(19) United States
(12) Patent Application Publication
(10) Pub. No.: US 2020/0302420 A1
(43) Pub. Date: Sep. 24, 2020

(54) CHECKOUT SYSTEM AND LANE SYSTEM

(71) Applicant: TOSHIBA TEC KABUSHIKI KAISHA, Tokyo (JP)

(72) Inventor: Tohru KOBAYASHI, Numazu Shizuoka (JP)

(73) Assignee: TOSHIBA TEC KABUSHIKI KAISHA, Tokyo (JP)

(21) Appl. No.: 16/713,900

(22) Filed: Dec. 13, 2019

(30) Foreign Application Priority Data
Mar. 18, 2019 (JP) 2019-049929

(51) Int. Cl. G06Q 20/20

(52) U.S. Cl. CPC G06Q 20/208

(57) ABSTRACT

A first lane system includes a first imaging device configured to acquire first information, and one first processor configured to perform a first determination for checkout based on the first information; perform a process related to the checkout in a first checkout lane in accordance with the first determination; and cause transmission of the first information to a second lane system. The second lane system includes a second imaging device configured to acquire second information, and one second processor configured to perform a second determination for checkout based on the information; perform a process related to the checkout in the second checkout lane in accordance with the second determination; perform a third determination for checkout based on the first information; and cause a notification to the first lane system of a determination result of the third determination.

### CROSS-REFERENCE TO RELATED APPLICATION

This application is based upon and claims the benefit of priority from Japanese Patent Application No. 2019-049929, filed on Mar. 18, 2019, the entire contents of which are incorporated herein by reference.

### FIELD

Embodiments described herein relate generally to a checkout system and a lane system.

### BACKGROUND

Point-of-sale (POS) terminals identifying merchandise using object recognition technologies without using barcodes are known.

However, advanced information processing is necessary to identify merchandise in a short time through object recognition technologies with high precision, and the POS terminals are more expensive than types of POS terminals identifying merchandise by reading barcodes. Devices and functions can be added as options to POS terminals in some cases, and there are various functional levels and prices in some cases.

When a plurality of checkout lanes are provided as in large stores such as supermarkets, devices of the lanes are unified in quite a few cases so that the same process can be performed in each lane. Therefore, cost burdens on store managers are large when devices with high functional levels are introduced.

In view of such circumstances, it is desirable to keep the cost low in entire checkout systems while enabling common functions to be used in each of checkout lanes.

### BRIEF DESCRIPTION OF THE DRAWINGS

FIG. 1 is a block diagram illustrating an overall configuration of a checkout system according to an embodiment;

FIG. 2 is a block diagram illustrating a main unit circuit configuration of a data processing unit, a barcode recognition unit, and an object recognition unit in FIG. 1;

FIG. 3 is a diagram schematically illustrating a configuration of a unit management record stored in an auxiliary storage device included in the data processing unit and the barcode recognition unit illustrated in FIG. 2;

FIG. 4 is a diagram schematically illustrating a configuration of a unit management record stored in the auxiliary storage device included in the object recognition unit illustrated in FIG. 2;

FIG. 5 is a flowchart illustrating a processing procedure in a barcode recognition process by a processor included in the barcode recognition unit in FIG. 2;

FIG. 6 is a flowchart illustrating a processing procedure in a sales process by a processor included in the data processing unit in FIG. 2; and

FIG. 7 is a flowchart illustrating a processing procedure in a merchandise recognition process by a processor included in the object recognition unit in FIG. 2.

### DETAILED DESCRIPTION

Embodiments provide a checkout system and a lane system keeping cost low in the entire checkout system while enabling common functions to be used in each of checkout lanes.

In general, according to at least one embodiment, a checkout system includes first and second lane systems associated with first and second checkout lanes. The first lane system includes a first imaging device configured to acquire first information. The first lane system includes at least one first processor configured to perform a first determination for checkout based on the first information acquired by the first imaging device; perform a process related to the checkout in a first checkout lane in accordance with a determination result of the first determination; and cause transmission of the first information acquired by the first imaging device to the second lane system. The second lane system includes a second imaging device configured to acquire second information. The second lane system includes at least one second processor configured to perform a second determination for checkout based on the information obtained by the second imaging device; perform a process related to the checkout in the second checkout lane in accordance with a determination result of the second determination; perform a third determination for checkout based on the first information transmitted by the first lane system; and cause a notification to the first lane system of a determination result of the third determination. The at least one first processor is configured to perform a process related to the checkout in the first checkout lane in accordance with the determination result of the third determination.

Hereinafter, embodiments will be described with reference to the drawings.

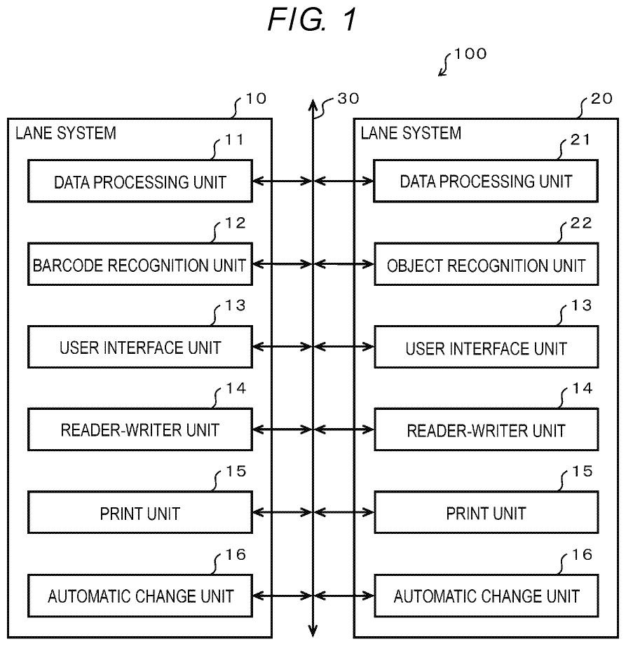

FIG. 1 is a block diagram illustrating an overall configuration of a checkout system 100 according to an embodiment.

The checkout system 100 is configured by connecting the lane systems 10 and 20 to a communication network 30. The lane system 10 is equivalent to a first lane system and the lane system 20 is equivalent to a second lane system. The checkout system 100 generally includes a plurality of lane systems 10 and a plurality of lane systems 20, but only one lane system 10 and one lane system 20 are illustrated in FIG. 1. The checkout system 100 includes any number of lane systems 10 and any number of lane systems 20. Hereinafter, it is assumed that the plurality of lane systems 10 and the plurality of lane system 20 are included in the checkout system 100.

The lane systems 10 and 20 are provided in separate checkout lanes. The lane systems 10 and 20 each perform a process for a checkout procedure of a shopper once a shopper enters each checkout lane. Thus, the checkout lanes in which the lane systems 10 and 20 are provided are equivalent to first and second checkout lanes, respectively.

The communication network 30 transmits data transmitted and received between connected communication devices. The communication network 30 is typically a local area network (LAN) provided in a store. However, the communication network 30 can be used using the Internet, a virtual private network (VPN), LAN, a public telecommunication network, a mobile communication network, a dedicated line, and the like singly or in appropriate combination.

The lane system 10 includes a data processing unit (data processor) 11, a barcode recognition unit (barcode reader or scanner) 12, a user interface unit (user interface) 13, a reader-writer unit (I/O device) 14, a print unit (printer) 15, and an automatic change unit (coin dispenser/receiver) 16. The data processing unit 11, the barcode recognition unit 12, the user interface unit 13, the reader-writer unit 14, the print unit 15, and the automatic change unit 16 are physically independent units and are individually connected to the communication network 30. The data processing unit 11, the barcode recognition unit 12, the user interface unit 13, the reader-writer unit 14, the print unit 15, and the automatic change unit 16 are associated to configure the lane system 10, as will be described below.

The data processing unit 11 performs data processing for registering merchandise to be purchased by a shopper as purchase merchandise and accounting for purchase merchandise. The data processing unit 11 is equivalent to a first information processing device.

The barcode recognition unit 12 optically reads a code symbol to recognize merchandise represented by the code symbol. For example, the barcode recognition unit 12 determines a merchandise code for identifying the merchandise. The merchandise code is, for example, a Japanese article number (JAN) code. The code symbol read by the barcode recognition unit 12 is typically a barcode such as a JAN symbol. However, the barcode recognition unit 12 may be able to read different code symbols such as 2-dimensional codes. The barcode recognition unit 12 is equivalent to a first scanner device.

The user interface unit 13 interfaces the data processing unit 11 and an operator. The user interface unit 13 includes, for example, an output device and an input device. The output device outputs various kinds of information of which the operator is notified. As the output device, devices such as display devices such as liquid crystal display devices or sound output devices such as sound reproduction devices can be applied singly or in combination. The input device inputs various instructions by the operator. As the input device, devices such as touch sensors or keyboards can be applied singly or in combination.

The reader-writer unit 14 reads data recorded on a recording medium. The reader-writer unit 14 writes data on a writable recording medium. As the reader-writer unit 14, devices such as an IC card reader-writer, a magnetic card reader-writer, and a proximity communication reader-writer can be applied singly or in combination. The reader-writer unit 14 can be used to read information regarding payment media for payment. The reader-writer unit 14 reads, for example, credit data recorded on a credit card. The reader-writer unit 14 reads, for example, electronic money data recorded on an electronic money card.

The print unit 15 prints any image on a loaded print sheet under an instruction from the data processing unit 11. The image printed by the print unit 15 is, for example, a receipt image indicating content of a transaction, a result of accounting, or the like.

The automatic change unit 16 receives inserted coins and paper money and stores the coins and paper money in a storage. The automatic change unit 16 pays out the coins and paper money stored in the storage as, for example, change money.

The lane system 20 includes the user interface unit 13, the reader-writer unit 14, the print unit 15, the automatic change unit 16, a data processing unit 21, and an object recognition unit 22. That is, the lane system 20 includes the user interface unit 13, the reader-writer unit 14, the print unit 15, and the automatic change unit 16 similar units to those of the lane system 10. Accordingly, description of these units will be omitted. The lane system 20 is different from the lane system 10 in that the data processing unit 21 and the object recognition unit 22 are included instead of the data processing unit 11 and the barcode recognition unit 12.

The data processing unit 21 performs data processing to register merchandise which a shopper is to purchase as purchase merchandise and account purchase merchandise. That is, the data processing unit 21 has a similar function to the data processing unit 11. However, the data processing unit 11 registers purchase merchandise in accordance with a recognition result in the object recognition unit 22 included in the lane system 20 in addition to a recognition result by the barcode recognition unit 12 and an instruction by an operation of the user interface unit 13 included in the lane system 10 to which the data processing unit 11 belongs. The data processing unit 21 registers purchase merchandise in accordance with an instruction by an operation of the user interface unit 13 and a recognition result by the object recognition unit 22 included in the lane system 20 to which the data processing unit 21 belongs, but does not register purchase merchandise in accordance with recognition results by the barcode recognition unit 12 and the object recognition unit 22 included in the other lane systems 10 and 20. The data processing unit 21 is equivalent to a second information processing device.

The object recognition unit 22 identifies merchandise based on an appearance feature of merchandise shown in an image. That is, the object recognition unit 22 identifies merchandise through image analysis using an object recognition technology. The object recognition unit 22 also has a function of recognizing merchandise indicated by a code symbol shown in an image. The object recognition unit 22 is equivalent to a second scanner device.

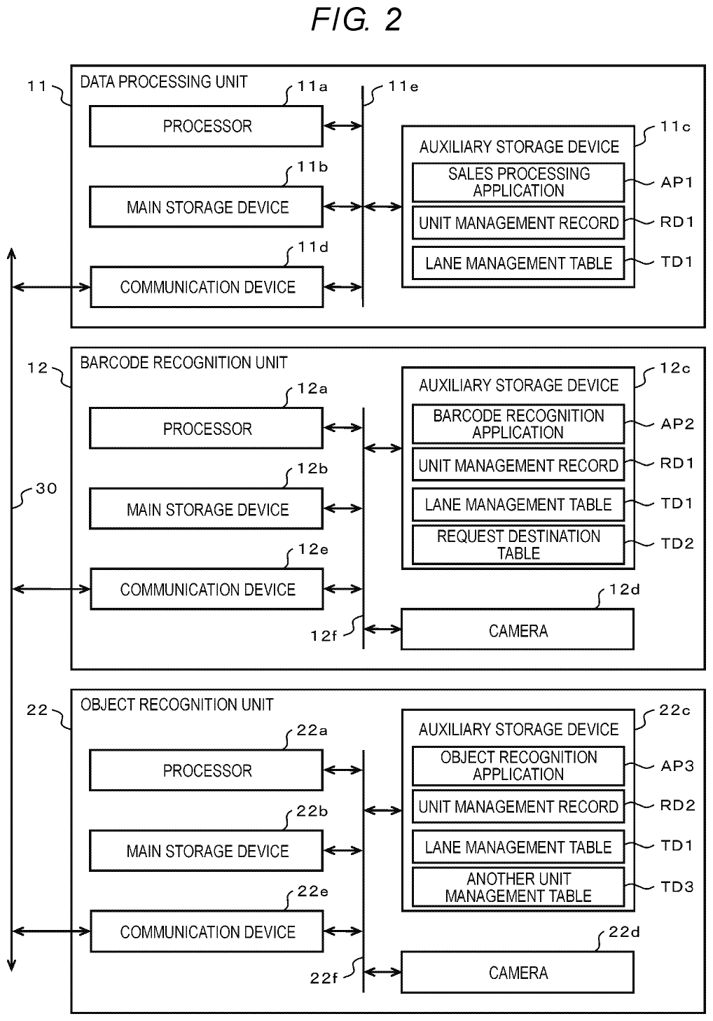

FIG. 2 is a block diagram illustrating a main unit circuit configuration of the data processing unit 11, the barcode recognition unit 12, and the object recognition unit 22. Each of the data processing unit 11, the barcode recognition unit 12, and the object recognition unit 22 may be a means for performing one or more of the functions, which will be described below.

The data processing unit 11 includes a processor 11a, a main storage device 11b, an auxiliary storage device 11c, a communication device 11d, and a transmission path 11e.

In the data processing unit 11, the processor 11a, the main storage device 11b, and the auxiliary storage device 11c are connected by the transmission path 11e to configure a computer that performs information processing to be performed by the data processing unit 11.

The processor 11a is equivalent to a central unit of the computer. The processor 11a performs information processing to realize various functions of the data processing unit 11 in accordance with an information processing program such as an application program, an operation system, and middleware.

The main storage device 11b is equivalent to a central storage unit of the computer. The main storage device 11b includes a non-volatile memory region and a volatile memory region. The main storage device 11b stores the information processing program in a non-volatile memory region. The main storage device 11b stores data necessary for the processor 11a to perform a process of controlling each unit in a non-volatile or volatile memory region in some cases. The main storage device 11b uses a volatile memory region as a working area in which the processor 11a can appropriately rewrite data.

The auxiliary storage device 11c is equivalent to an auxiliary storage unit of the computer. As the auxiliary storage device 11c, for example, any of an electric erasable programmable read-only memory (EEPROM), a hard disk drive (HDD), a solid-state drive (SSD), and other various storage devices can be used. The auxiliary storage device 11c stores data to be used for the processor 11a to perform various processes and data generated through a process by the processor 11a. The auxiliary storage device 11c stores the information processing program in some cases. In the embodiment, the auxiliary storage device 11c stores an application program (hereinafter referred to as a sales processing application) AP1 described for information processing to be described below. The auxiliary storage device 11c stores a unit management record RD1 and a lane management table TD1. The unit management record RD1 and the lane management table TD1 will be described later.

The communication device 11d performs data communication via the communication network 30. As the communication device lid, for example, a device configured to perform a process for data communication via a LAN can be used.

The transmission path 11e includes an address bus, a data bus, and a control signal line and transmits data or a control signal transmitted to and received from each of the connected units.

The barcode recognition unit (reader) 12 includes a processor 12a, a main storage device 12b, an auxiliary storage device 12c, a camera 12d, a communication device 12e, and a transmission path 12f.

In the barcode recognition unit 12, the processor 12a, the main storage device 12b, and the auxiliary storage device 12c are connected by the transmission path 12f to configure a computer that performs information processing to be performed by the barcode recognition unit 12. The overview of the functions of the processor 12a, the main storage device 12b, the auxiliary storage device 12c, the communication device 12e, and the transmission path 12f are similar to those of the processor 11a, the main storage device 11b, the auxiliary storage device 11c, the communication device 11d, and the transmission path 11e, and thus description thereof will be omitted.

Here, the auxiliary storage device 12c stores an application program (hereinafter referred to as a barcode recognition application) AP2 in which information processing is to be described below. The auxiliary storage device 12c stores the unit management record RD1, the lane management table TD1, and a request destination table TD2. The request destination table TD2 will be described later.

The camera 12d images merchandise held over by an operator using the camera 12d. Then, the camera 12d outputs image data indicating an image obtained through the imaging. The camera 12d is, for example, a color video camera. The camera 12d is an example of a first acquisition unit (first imaging device) and an image is an example of information to be acquired.

The object recognition unit 22 includes a processor 22a, a main storage device 22b, an auxiliary storage device 22c, a camera 22d, a communication device 22e, and a transmission path 22f.

In the object recognition unit 22, the processor 22a, the main storage device 22b, and the auxiliary storage device 22c are connected by the transmission path 22f to configure a computer that performs information processing to be performed by the object recognition unit 22. The overview of the functions of the processor 22a, the main storage device 22b, the auxiliary storage device 22c, the camera 22d, the communication device 22e, and the transmission path 22f are similar to those of the processor 11a, the main storage device 11b, the auxiliary storage device 11c, the camera 12d, the communication device 11d, and the transmission path 11e, and thus description thereof will be omitted. The camera 22d is an example of a second acquisition unit (second imaging device) and an image is an example of information to be acquired.

Here, the auxiliary storage device 22c stores an application program (hereinafter referred to as an object recognition application) AP3 in which information processing is to be described below. The auxiliary storage device 22c stores the unit management record RD2, the lane management table TD1, and another unit management table TD3. The unit management record RD2 and the other unit management table TD3 will be described later.

The sales processing application AP1, the barcode recognition application AP2, and the object recognition application AP3 maybe stored in the auxiliary storage devices 11c, 12c, and 22c at the time of transfer of hardware of each unit or may be transferred apart from the hardware. In the latter case, each application program may be recorded on a removable recording medium such as a magnetic disk, a magneto-optical disc, an optical disc, or a semiconductor memory or may be transferred via a network. In the latter case, a scenario in which each application program is provided as a version upgrade program and is substituted with other similar kinds of application programs stored in the auxiliary storage device 11c, 12c, and 22c for use is assumed. Each application program may be stored in the main storage devices 11b, 12b, and 22b.

Meanwhile, each unit included in the lane systems 10 and 20 and connected to the communication network 30 stores the unit management record RD1 or the unit management record RD2 and the lane management table TD1 in an internal storage device. The unit management record RD2 is associated with a unit that has a function of supporting a process in the other lane system in response to a request form the other lane system (hereinafter referred to as a support function). The unit management record RD1 is associated with a unit that has no support function. The unit management records RD1 and RD2 are stored in a storage device included in the associated unit. That is, since the data processing unit 11 and the barcode recognition unit 12 have no support function, the unit management record RD1 is stored in the auxiliary storage devices 11c and 12c. Since the object recognition unit 22 has the support function, the unit management record RD2 is stored in the auxiliary storage device 22c.

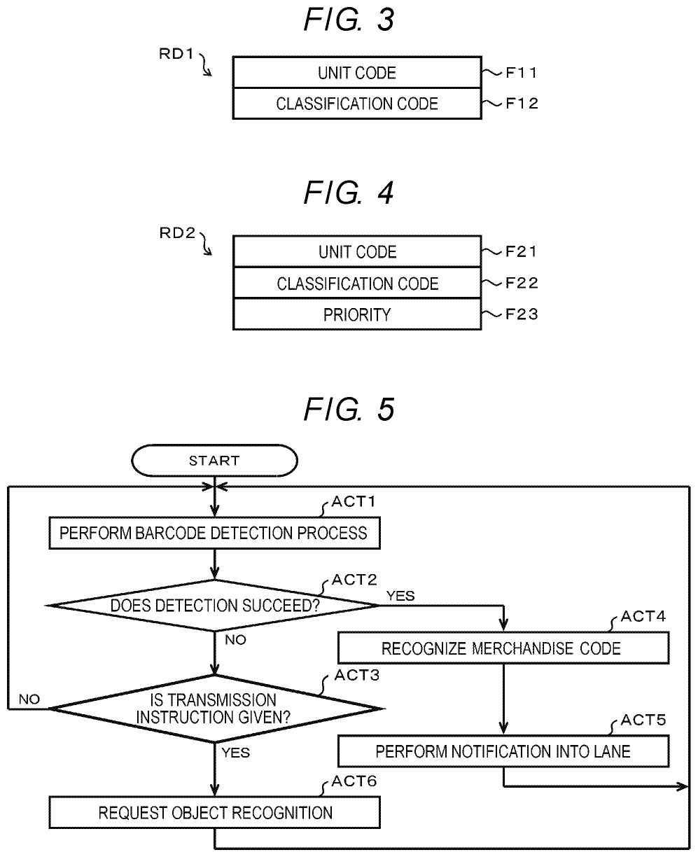

FIG. 3 is a diagram schematically illustrating a configuration of the unit management record RD1.

The unit management record RD1 is record data that includes fields F11 and F12.

In the field F11, a pre-decided unit code for identifying a unit associated with the unit management record RD1 is set. The unit code is determined to be able to identify all the units included in the checkout system 100.

In the field F12, a classification code for identifying classification of a unit associated with the unit management record RD1 is set. In the embodiment, the classification code is determined to identify at least the data processing unit, the barcode recognition unit, the user interface unit, the reader-writer unit, the print unit, the automatic change unit, and the object recognition unit. The checkout system 100 may include a unit different from each of the above-described units. When there is such a unit, the classification code is determined to be able to also identify the classification of the unit. The different kind of unit from each of the above-described units is, for example, a drawer unit.

That is, in the unit management record RD1 stored in the auxiliary storage device 11c of the data processing unit 11, a unit code determined to identify the data processing unit 11 from each of the different units and a classification code determined for the “data processing unit” are set in the fields F11 and F12, respectively. In the unit management record RD1 stored in the auxiliary storage device 12c of the barcode recognition unit 12, a unit code determined to identify the barcode recognition unit 12 from each of the different units and a classification code determined for the “barcode recognition unit” are set in the fields F11 and F12, respectively.

FIG. 4 is a diagram schematically illustrating a configuration of the unit management record RD2.

The unit management records RD2 is a data record that includes fields F21, F22, and F23. In the fields F21 and F22, a unit code and a classification code are set as in the fields F11 and F12 of the unit management record RD1. In the field F23, priority determined between same kinds of different units included in the checkout system 100 is set. For example, when the checkout system 100 includes three lane systems 20, priorities “1,” “2,” and “3” are determined for three object recognition units 22 included in the checkout system and the priorities are set in the field F13.

That is, in the unit management record RD2 stored in the auxiliary storage device 22c of the object recognition unit 22 in which “2” is determined as the priority, the unit code determined to identify the object recognition unit 22 from each of the other units, the classification code determined for the “object recognition unit,” and the priority of “2” are set in the fields F21, F22, and F23, respectively.

The lane management table TD1 is table data indicating association of the units included in one of the lane systems 10 and 20. For example, the lane management table TD1 is a set of the unit management records RD1 and RD2 associated with the units included in the lane systems 10 and 20 along with the units storing the lane management table TD1. That is, the lane management table TD1 stored in the auxiliary storage device 11c of the data processing unit 11 includes the unit management record RD1 associated with each of the barcode recognition unit 12, the user interface unit 13, the reader-writer unit 14, the print unit 15, and the automatic change unit 16 belonging to the same lane system 10 to the data processing unit 11. The lane management table TD1 stored in the auxiliary storage device 21c of the data processing unit 21 includes the unit management record RD1 associated with each of the user interface unit 13, the reader-writer unit 14, the print unit 15, and the automatic change unit 16 belonging to the same lane system 20 as the data processing unit 21 and the unit management record RD2 associated with the object recognition unit 22. Thus, content of the lane management table TD1 stored in each unit is different. Here, the unit management record RD1 related to the unit storing the lane management table TD1 may also be included in the lane management table TD1 and the content of the lane management table TD1 stored in each unit belonging to the same lane systems 10 and 20 may be unified.

The request destination table TD2 is table data for managing the object recognition unit 22 which is a candidate of a request destination related to a request for object recognition to be described below. For example, the request destination table TD2 is a set of the unit management record RD2 associated with the object recognition unit 22 included in the checkout system 100. That is, for example, when three lane systems 20 are included in the checkout system 100, the request destination table TD2 including each unit management record RD2 stored in the auxiliary storage devices 22c of the object recognition units 22 provided in the three lane systems 20 are stored.

It is not necessary to include all the unit management records RD2 associated with all the object recognition units included in the checkout system 100 in the request destination table TD2. That is, when some of the object recognition units 22 included in the checkout system 100 are not request destinations, the unit management records RD2 related to the object recognition units 22 are not included in the request destination table TD2.

When the plurality of lane systems 10 are included in the checkout system 100, the request destination table TD2 stored in each of the barcode recognition units 12 included in the plurality of lane systems 10 may not necessarily be in common. That is, candidates of request destinations may be different in the plurality of barcode recognition units 12.

The other unit management table TD3 is table data for managing other units that have the same kind of support function. Accordingly, the other unit management table TD3 is stored in a unit that has the support function, such as the object recognition unit 22. For example, the other unit management table TD3 is a set of the unit management records RD2 associated with the same kind of units belonging to the other lane system 20. That is, for example, when three lane systems 20 are included in the checkout system 100, the other unit management table TD3 including the unit management records RD2 associated with two different lane systems 20 are stored in the auxiliary storage device 22c of the object recognition unit 22 provided in one of the lane systems 20.

Each of the tables is generated in response to an instruction by a worker who constructs and maintains the checkout system 100, a manager of the checkout system 100, or the like. Alternatively, each table is automatically generated by the processor of each unit by collecting the unit management records RD1 from other units.

Next, an operation of the checkout system 100 that has the above-described configuration will be described. Content of various processes to be described below are exemplary, and a change in a procedure of some processes, omission of some processes, addition of other processes, and the like can be appropriately made.

When an operation mode in which the barcode recognition unit 12 recognizes a barcode is set, the processor 12a performs information processing (hereinafter referred to as a barcode recognition process) to be described below in accordance with the barcode recognition application AP2.

FIG. 5 is a flowchart illustrating a processing procedure of the processor 12a in a barcode recognition process.

In ACT1, the processor 12a performs a barcode detection process. The processor 12a attempts, for example, to extract a region in which a barcode is shown through image processing setting image data output by the camera 12d as a processing target. Then, when the processor 12a can extract the region, the processor 12a attempts to detect the barcode indicating merchandise code from the image of the region.

In ACT2, the processor 12a checks whether the detection of the barcode succeeds in ACT1. Then, when the processor 12a does not detect the barcode indicating the merchandise code, the processor 12a determines NO, and then the process proceeds to ACT3.

In ACT3, the processor 12a checks whether an instruction to recognize an object is given. Then, when the processor 12a checks no such an instruction, the processor 12a determines NO, and then the process returns to ACT1.

Thus, the processor 12a waits for receiving detection of the barcode indicating the merchandise code or instruction of object recognition in ACT1 to ACT3.

When an operator registers purchase merchandise using the barcode, the operator holds up the barcode indicating the merchandise code of the product to the camera 12d. Thus, when the barcode is shown in the image captured by the camera 12d, the processor 12a can detect the barcode indicating the merchandise code in ACT1. Then, when the processor 12a detects the barcode in ACT1, the processor 12a determines YES in ACT2, and then the process proceeds to ACT4.

In ACT4, the processor 12a recognizes the merchandise code from the detected barcode. In this way, the processor 12a recognizes the merchandise as determination for checkout based on the image obtained through imaging in the camera 12d. Accordingly, when the processor 12a performs information processing based on the barcode recognition application AP2, a computer that has the processor 12a as a central unit functions as a first determination unit.

In ACT5, the processor 12a performs notification for the merchandise code recognized in ACT4 into the same lane system 10. The processor 12a extracts the unit management record RD1 in which the classification code indicating the “data processing unit” is set in the field F12, for example, from the lane management table TD1. The processor 12a determines the unit identified with the unit code set in the field F11 of the unit management record RD1, that is, the data processing unit 11 belonging to the same lane system 10 as a notification destination. Then, the processor 12a transmits the notification data in which the data processing unit 11 determined as the notification destination is set as the destination from the communication device 12e to the communication network 30 in addition to the merchandise code recognized in ACT4. Thereafter, the processor 12a returns to a waiting state of ACT1 to ACT3.

Meanwhile, when an operation mode in which the data processing unit 11 performs a process of registering and accounting for purchase merchandise is set, the processor 11a performs information processing (hereinafter referred to as sales processing) to be described below in accordance with the sales processing application AP1.

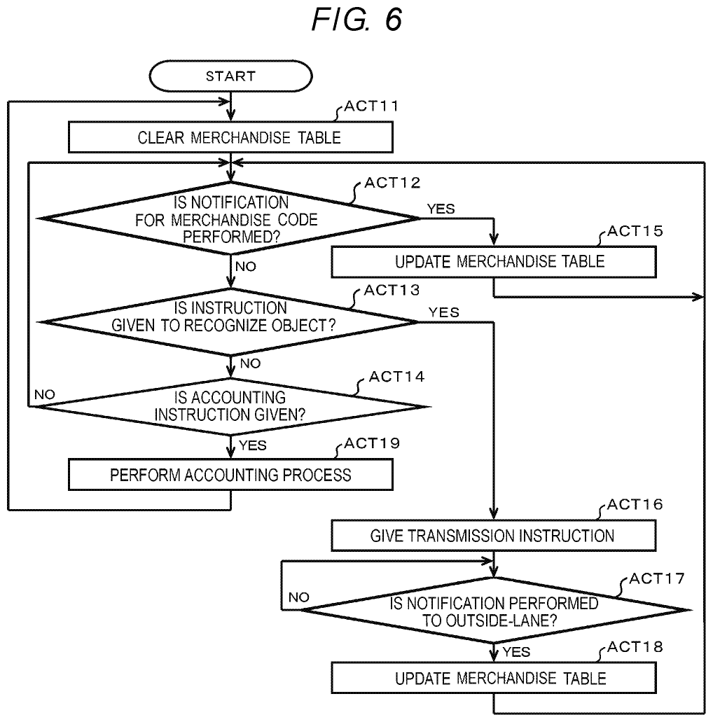

FIG. 6 is a flowchart illustrating a processing procedure of the processor 11a in a sales process.

In ACT11, the processor 11a clears the merchandise table. The merchandise table is table data indicating a list of purchase merchandise and is stored in, for example, the auxiliary storage device 11c.

In ACT12, the processor 11a checks whether the merchandise code is notified. Then, when the processor 11a determines no such notification, the processor 11a determines NO, and then the process proceeds to ACT13.

In ACT13, the processor 11a checks whether an instruction to recognize an object is given. Then, when the processor 11a determines no such instruction, the processor 11a determines NO, and then the process proceeds to ACT14.

In ACT14, the processor 11a checks whether an accounting instruction is given. Then, when the processor 11a determines no such instruction, the processor 11a determines NO, and then the process returns to ACT12.

Accordingly, the processor 11a waits for notifying the merchandise code or receiving either instruction to recognize an object or an accounting instruction in ACT12 to ACT14.

When the communication device 11d receives the notification data transmitted from the barcode recognition unit 12, as described above, the processor 11a determines YES in ACT12, and then the process proceeds to ACT15. When the operator performs an operation of designating purchase merchandise in the user interface unit 13, the user interface unit 13 transmits the notification data including the merchandise code of the designated purchase merchandise and destined for the data processing unit 11 belonging to the same lane system 10 to the communication network 30. Even when the notification data is received by the communication device 11d, the processor 11a determines YES in ACT12, and then the process proceeds to ACT15.

In ACT15, the processor 11a updates the merchandise table. For example, when the merchandise code included in the received notification data is not yet included in the merchandise table, the processor 11a updates the merchandise table so that the merchandise code is included and the number of merchandise codes is “1”. For example, when the merchandise code included in the received notification data is already included in the merchandise table, the processor 11a increases a number associated with the merchandise code by 1. Then, when the updating of the merchandise table ends, the processor 11a returns to a standby state of ACT12 to ACT14. In this way, registration of the merchandise identified as a result of the barcode recognition by the processor 11a as for purchase merchandise is an example of a process related to checkout. Accordingly, when the processor 11a performs information processing based on the sales processing application AP1, a computer that has the processor 11a as a central unit functions as a first processing unit.

The operator operates the user interface unit 13 to designate purchase merchandise, as described above, when the barcode recognition unit 12 does not read the barcode of the merchandise registered as purchase merchandise. Alternatively, in a state in which the operator holds up the merchandise to the camera 12d, the operator performs a pre-decided operation in the user interface unit 13 to give an instruction to recognize an object. Then, the user interface unit 13 transmits the pre-decided notification data used for notifying that the instruction to recognize the object is given and destined for the data processing unit 11 belonging to the same lane system 10 to the communication network 30. When the notification data is received by the communication device 11d, the processor 11a determines YES in ACT13, and the process proceeds to ACT16.

In ACT16, the processor 11a transmits pre-decided instruction data for instructing the barcode recognition unit 12 belonging to the same lane system 10 to transmit the image from the communication device 11d to the communication network 30.

When the instruction data is received by the communication device 12e, the processor 12a determines YES in ACT3 in FIG. 5, and then the process proceeds to ACT6.

In ACT6, the processor 12a requests the object recognition unit 22 to recognize the object. For example, the processor 12a determines the object recognition unit 22 identified with the unit code set in the field F21 of the unit management record RD2 included in the request destination table TD2 stored in the auxiliary storage device 22c as a request destination. When the plurality of unit management records RD2 are included in the request destination table TD2, the processor 12a determines all the plurality of object recognition units 22 identified with the unit codes set in the fields F21 of the plurality of unit management records RD2 as request destinations. The processor 12a determines the self-barcode recognition unit 12 and the data processing unit 11 belonging to the same lane system 10 as the notification destinations of the recognition result. For example, the processor 12a extracts the unit management record RD1 in which the classification code indicating the “data processing unit” is set in the field F12 from the lane management table TD1 stored in the auxiliary storage device 12c. The processor 12a determines the unit identified with the unit code set in the field F11 of the unit management record RD1 as a notification destination. Then, the processor 12a transmits one piece of request data or a plurality of pieces of request data which include image data output by the camera 12d and the unit code of the data processing unit 11 determined as the notification destination and are destined for the object recognition unit determined as the request destination, from the communication device 12e to the communication network 30. Thereafter, the processor 12a returns to a standby state of ACT1 to ACT3. Here, since the request data includes the image data, as described above, the transmission of the request data is equivalent to transmission of an image to the lane system 20. Accordingly, when the processor 12a performs information processing based on the barcode recognition application AP2, a computer that has the processor 12a as a central unit functions as a transmission unit.

When an operation mode in which the object recognition unit 22 recognizes merchandise is set, the processor 22a performs information processing (hereinafter referred to as a merchandise recognition process) to be described below in accordance with the object recognition application AP3.

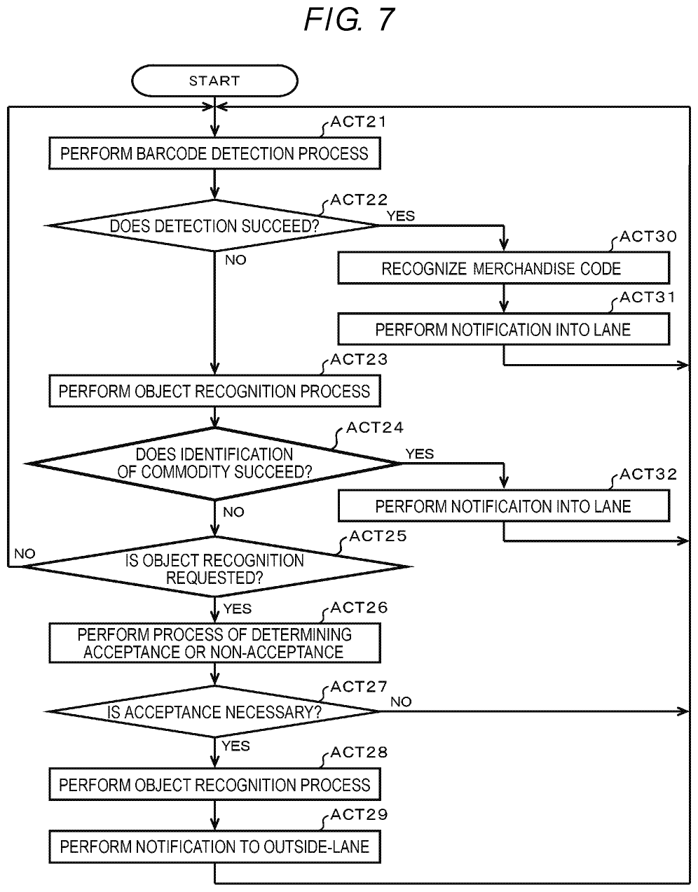

FIG. 7 is a flowchart illustrating a processing procedure of the processor 22a in a merchandise recognition process.

In ACT21, the processor 22a performs a barcode detection process. The barcode detection process may be, for example, a similar process to the process performed by the processor 12a in ACT1 in FIG. 5.

In ACT22, the processor 22a checks whether the detection of the barcode succeeds in ACT21. Then, when a barcode indicating a merchandise code is not detected, the processor 22a determines NO, and then the process proceeds to ACT23.

In ACT23, the processor 22a performs an object recognition process. For example, the processor 22a attempts to extract a region in which merchandise is shown through image processing setting image data output by the camera 22d as a processing target. Then, when the processor 22a can extract the region, the processor 12a obtains feature data of the appearance of the merchandise shown in the region and attempts to identify the merchandise based on the feature data.

In ACT24, the processor 22a checks whether the identification of the merchandise through the object recognition succeeds. Then, when the processor 22a does not identify the merchandise, the processor 22a determines NO, and then the process proceeds to ACT25.

In ACT25, the processor 22a checks whether object recognition is requested. Then, when the processor 22a determines no such request, the processor 22a determines NO, and then the process returns to ACT21.

Accordingly, the processor 22a waits for the success of the barcode detection, the success of the merchandise identification through the object recognition, or reception of the request for the object recognition in ACT21 to ACT25.

Meanwhile, when request data in which the self-object recognition unit 22 is a destination is transmitted via the communication network 30, the communication device 22e receives the request data. Then, when the processor 22a receives the request data in this way, the processor 22a determines YES in ACT25, and then the process proceeds to ACT26.

In ACT26, the processor 22a determines whether it is necessary to accept the request for the object recognition. That is, when the request for the object recognition is made for the plurality of object recognition units 22, one of the plurality of object recognition units 22 accepts the request in accordance with a pre-decided rule. For example, it is assumed that while notification is performed between the plurality of object recognition units 22 which are request destinations, the object recognition process can be performed and the object recognition unit 22 with higher priority accepts the request.

In ACT27, the processor 22a checks whether acceptance is necessary through the determination process. When the acceptance is necessary, the processor 22a determines YES, and then the process proceeds to ACT28.

In ACT28, the processor 22a performs the object recognition process. Herein, in the object recognition process, the process of identifying the merchandise based on image data by the object recognition technology is similar to ACT23, but the image data which is a processing target is image data included in requested data. In this way, the processor 22a recognizes merchandise through the object recognition as determination for checkout based on an image notified of by the lane system 10. Accordingly, when the processor 22a performs information processing based on the object recognition application AP3, a computer that has the processor 22a as a central unit functions as a third determination unit.

In ACT29, the processor 22a transmits notification data including a merchandise code of the merchandise recognized through the object recognition process and destined for the data processing unit 11 identified with the unit code included as a notification destination in the request data, from the communication device 22e to the communication network 30. That is, the notification of the recognition result herein is notification to the other lane system 10, that is, outside-lane notification. Then, when the notification ends, the processor 22a returns to the standby state of ACT21 to ACT25. When the merchandise is not identified in ACT28, the processor 22a includes a failure code indicating a recognition failure in the notification data instead of the merchandise code. Accordingly, when the processor 22a performs information processing based on the object recognition application AP3, a computer that has the processor 22a as a central unit functions as a communication unit.

Meanwhile, after the processor 11a in the data processing unit 11 performs the transmission instruction in ACT16 in FIG. 6, the process proceeds to ACT17.

In ACT17, the processor 11a waits for the outside-lane notification from the object recognition unit 22, as described above. Then, when the notification data transmitted from the object recognition unit 22, as described above, is received for the outside-lane notification by the communication device 11d, the processor 11a determines YES in ACT17, and then the process proceeds to ACT18.

In ACT18, the processor 11a updates the merchandise table based on the notification in accordance with the notification data received by the communication device 11d. For example, when the merchandise code included in the received notification data is not yet included in the merchandise table, the processor 11a updates the merchandise table so that the merchandise code is included. For example, when the merchandise code included in the received notification data is already included in the merchandise table, the processor 11a increases a number associated with the merchandise code by 1. Then, when the updating of the merchandise table ends, the processor 11a returns to a standby state of ACT12 to ACT14. For example, when the failure code is included in the received notification data, the processor 11a does not update the merchandise table and returns to the standby state of ACT12 to ACT14.

In this way, the registration of purchase merchandise by the data processing unit 11 based on the capturing of the merchandise image in the barcode recognition unit 12 in the lane system 10 is performed using the support function of the object recognition unit 22. Accordingly, when the processor 11a performs information processing based on the sales processing recognition application AP1, a computer that has the processor 11a as a central unit functions as a third processing unit.

When the operator ends designation of all purchase merchandise and the process proceeds to accounting, the user interface unit 13 performs a pre-decided operation for an accounting instruction. Then, the user interface unit 13 transmits the pre-decided notification data used for notifying an accounting instruction and destined for the data processing unit 11 belonging to the same lane system 10 to the communication network 30. In the data processing unit 11 which is a destination of the notification data, when the notification data is received by the communication device 11d, the processor 11a determines YES in ACT14 in FIG. 6, and then the process proceeds to ACT19.

In ACT19, the processor 11a performs a process for accounting related to purchase merchandise registered in the merchandise table. The processor 11a calculates, for example, a payment amount of purchase merchandise. Then, the processor 11a makes the payment amount. In the accounting process, the processor 11a makes a request to the user interface unit 13 and performs display or the like to notify the operator related to the accounting of various kinds of information. The processor 11a is notified by the user interface unit 13 to receive a designation of a payment medium to be used for payment. The processor 11a is notified by the reader-writer unit 14 or the automatic change unit 16 to acquire data for payment such as a credit card number, a prepaid balance, and an electronic money balance or an inserted cash. The processor 11a requests the reader-writer unit 14 or the automatic change unit 16 to rewrite the prepaid balance or the electronic money balance or dispense a change. Further, the processor 11a requests the print unit 15 to issue a receipt. When the processor 11a ends the accounting process, the process returns to ACT11.

Incidentally, when a barcode of merchandise to be purchased by a shopper entering a checkout lane in which the lane system 20 is provided is held up to the camera 22d by the operator of the lane system 20, the processor 22a can detect the barcode indicating the merchandise code through the barcode detection process of ACT21. Then, when the detection of the barcode succeeds, the processor 12a determines YES in ACT22, and then the process proceeds to ACT30.

In ACT30, the processor 22a recognizes the merchandise code from the detected barcode.

In ACT31, the processor 22a performs notification for the merchandise code recognized in ACT30 into the same lane system 20. For example, the processor 22a extracts the unit management record RD1 in which the classification code indicating the “data processing unit” is set in the field F12 from the lane management table TD1 stored in the auxiliary storage device 22c. The processor 22a notifies the unit identified with the unit code set in the field F11 of the unit management record RD1, that is, the data processing unit 21 belonging to the same lane system 20, of the merchandise code from the communication device 22e via the communication network 30. Thereafter, the processor 22a returns to the standby state of ACT21 to ACT25.

When merchandise to be purchased by a shopper entering a checkout lane in which the lane system 20 is provided is approximately held up to the camera 22d by the operator of the lane system 20, the processor 22a can identify the merchandise through the object recognition process of ACT23. Then, when the recognition of the merchandise succeeds in this way, the processor 12a determines YES in ACT24, and then the process proceeds to ACT32.

In ACT32, the processor 22a performs notification for the merchandise code of the merchandise recognized in ACT23 into the same lane system 20 similarly to ACT31. Thereafter, the processor 22a returns to the standby state of ACT21 to ACT25.

In this way, the processor 22a recognizes the merchandise as determination for checkout through the barcode recognition or the object recognition based on the image obtained through imaging in the camera 22d. Accordingly, when the processor 22a performs information processing based on the object recognition application AP3, a computer that has the processor 22a as a central unit functions as a second determination unit.

The data processing unit 21 registers the merchandise recognized or designated within the same lane system 20 as purchase merchandise related to the checkout lane in which the lane system 20 is provided. That is, the processor of the data processing unit 21 performs, for example, processes except for ACT13 and ACT16 to ACT18 in the sales processing illustrated in FIG. 6. In this way, the registration of the merchandise identified as the result of the barcode recognition or the object recognition as purchase merchandise by the processor of the data processing unit 21 is an example of a process related to checkout. Accordingly, when the processor of the data processing unit 21 performs information processing, a computer that has the processor as a central unit functions as a second processing unit.

In the above-described checkout system 100, by using the support function of the object recognition unit 22 provided in the lane system 20, purchase merchandise can be registered by merchandise identification using the object recognition even in the lane system 10. Thus, in either the lane system 10 or 20, purchase merchandise can be registered by the barcode recognition and the object recognition. In addition, the lane system 10 includes the cheap barcode recognition unit 12 since the barcode recognition unit 12 has a lower function than the object recognition unit 22. Accordingly, it is possible to suppress cost of the entire checkout system while enabling common functions to the plurality of checkout lanes to be used.

In the checkout system 100, the version of the lane system 10 can be upgraded to the lane system 20 by exchanging the data processing unit 11 and the barcode recognition unit 12 with the data processing unit 21 and the object recognition unit 22. Accordingly, when a load of the object recognition unit 22 is excessive, optimization of the system can be achieved by upgrading a version of a part of the lane system 10 to the lane system 20.

The embodiment can be modified in various forms as follows.

The process supported by the support function is not limited to the merchandise recognition by the object recognition. Any content of the process may be used as long as, for processes in one checkout lane, information acquired in a lane system corresponding to the checkout lane is processed by the support function within the lane systems corresponding to other checkout lanes.

In the lane systems 10 and 20, all of the included units or some of the units may be substituted with one unit that has the functions of the units. For example, the lane systems 10 and 20 maybe realized as a single device such as a POS terminal.

Some or all of the functions realized by the processors 11a, 12a, and 22a by the information processing can also be realized by hardware that performs information processing which is not based on a program, such as a logical circuit. Each of the foregoing functions can also be realized by combining software control with the hardware such as the logical circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout system comprising:
first and second lane systems associated with first and second checkout lanes, wherein the first lane system includes
a first imaging device configured to acquire first information,
at least one first processor configured to
perform a first determination for checkout based on the first information acquired by the first imaging device,
perform a process related to the checkout in a first checkout lane in accordance with a determination result of the first determination, and
cause transmission of the first information acquired by the first imaging device to the second lane system,
the second lane system includes
a second imaging device configured to acquire second information,
at least one second processor configured to
perform a second determination for checkout based on the second information obtained by the second imaging device,
perform a process related to the checkout in the second checkout lane in accordance with a determination result of the second determination,
perform a third determination for checkout based on the first information transmitted by the first lane system, and
cause a notification to the first lane system of a determination result of the third determination,
wherein the at least one first processor is configured to perform a process related to the checkout in the first checkout lane in accordance with the determination result of the third determination.

2. The system according to claim 1, wherein
each of the first and second imaging devices is configured to acquire image data as the information,
each of the at least one first and second processors is configured to
determine merchandise based on the image data acquired by each of the first and second imaging devices,
perform a process of registering the merchandise determined by each of the at least one first and second processors as purchase merchandise related to each of the first and second checkout lanes,
the third determination includes identification of merchandise based on the image transmitted by the first lane system,
the notification notifies the first lane system of the merchandise determined by the third determination, and
the at least one second processor is configured to perform a process of registering the merchandise notified of by the second lane system as purchase merchandise related to the first checkout lane.

3. The system according to claim 2, wherein
the at least one first processor is configured to determine merchandise from an optically readable code pattern shown in the image acquired by the first imaging device, and
in each of the second and third determinations, the at least one second processor is configured to determine the merchandise from an appearance of the merchandise shown in the image data transmitted by the first lane system and the image acquired by the second imaging device.

4. The system according to claim 2, wherein
the first lane system includes a first scanner device and a first information processing device,
the first scanner device includes the first imaging device, and the at least one first processor,
the second lane system includes a second scanner device and a second information processing device,
the second scanner device includes the second imaging device and the at least one second processor.

5. A lane system that is associated with one checkout lane and is included in a checkout system along with another lane system associated with another checkout lane, the system comprising:
a first imaging device configured to acquire information,
at least one first computer configured to
perform a first determination for a checkout based on the information acquired by the first imaging device;
perform a process related to the checkout in the checkout lane in accordance with a determination result of the first determination; and
a transmitter configured to transmit the information acquired by the first imaging device to the another lane system; and
wherein the at least one first computer is configured to perform a process related to checkout in the checkout lane in accordance with a determination result in the another lane system based on the information transmitted by the transmitter.

6. A first lane system associated with a first checkout lane and included in a checkout system along with a second lane system associated with a second checkout lane, the first lane system comprising:
a first imaging device configured to acquire information,
at least one processor configured to
perform a first determination for checkout based on the information acquired by the first imaging device;
perform a process related to the checkout in the first checkout lane in accordance with a determination result by the at least one processor;
perform a second determination for checkout based on information transmitted from the second lane system; and
notifying the second lane system of a determination result of the second determination.

7. A method, comprising:
acquiring, by a first lane system of a checkout system associated with a first checkout lane, first information;
performing, by the first lane system, a first determination for checkout based on the first information;
performing, by the first lane system, a process related to the checkout in a first checkout lane in accordance with a determination result of the first determination;
causing, by the first lane system, transmission of the first information to a second lane system of the checkout system associated with a second checkout lane;
acquiring, by the second lane system, second information;
performing, by the second lane system, a second determination for checkout based on the second information;
performing, by the second lane system, a process related to the checkout in the second checkout lane in accordance with a determination result of the second determination;
performing, by the second lane system, a third determination for checkout based on the first information transmitted by the first lane system;
causing, by the second lane system, a notification to the first lane system of a determination result of the third determination; and
performing, by the first lane system, a process related to the checkout in the first checkout lane in accordance with the determination result of the third determination.
